(19) United States
(12) Patent Application Publication
(10) Pub. No.: US 2012/0033244 A1
(43) Pub. Date: Feb. 9, 2012

(54) Data relay apparatus, print control method, and computer program product

(75) Inventor: Akira Kohno, Kanagawa (JP)

(73) Assignee: Ricoh Company, Limited, Tokyo (JP)

(21) Appl. No.: 13/137,246

(22) Filed: Aug. 1, 2011

(30) Foreign Application Priority Data
Aug. 9, 2010 (JP) 2010-178596

(51) Int. Cl. G06K 15/02

(52) U.S. Cl. 358/1.14; 358/1.15

(57) ABSTRACT

A data relay apparatus includes a connecting unit that connects an information processing apparatus to an image forming apparatus; a print control unit that receives output data from the information processing apparatus, produces print data based on the output data, and outputs the print data to the image forming apparatus; an information extracting unit that retrieves, from the output data, trigger data instructing execution of processing and extracts information within a preset data range subsequent to the trigger data; a setting unit that sets the data range according to an instruction from outside; a processing unit that executes the processing based on the trigger data and the information within the data range; a log-information generating unit that generates log information about the processing executed by the processing unit; and a log-information output unit that outputs the log information.

### CROSS-REFERENCE TO RELATED APPLICATIONS

The present application claims priority to and incorporates by reference the entire contents of Japanese Patent Application No. 2010-178596 filed in Japan on Aug. 9, 2010.

### BACKGROUND OF THE INVENTION

1. Field of the Invention

The present invention relates to a data relay apparatus that receives data from an information processing apparatus, such as a mainframe computer (which is hereafter called ‘mainframe’ for short), a personal computer (PC), or a server, and outputs print data (data for forming an image) to an image forming apparatus, a print control method to implement functions necessary for a computer to control the data relay apparatus (functions according to the present invention), a computer program product on which a print control program is stored.

2. Description of the Related Art

In a case in which, for instance, a large amount of printed matter (printouts), such as business forms, is to be produced or a case in which a mainframe executes a business application program and outputs an execution result, conventionally widely practiced is transmitting a print request or data from a terminal computer to the mainframe and causing the mainframe to perform a corresponding operation and output a result of the operation to an image forming apparatus, such as a line printer, a laser printer, or an MFP, to print out the result.

In many cases, a mainframe uses its own operating system to perform its process and produces an output that is generally described in a dedicated language to print a line output adapted to a line printer. A terminal computer typically accesses the mainframe, by using a user ID and a password, transmits data to the mainframe, and requests the mainframe to perform the process.

Conventionally, it has been assumed that outputs of a mainframe are printed by a line printer or the like; however, with increasing processing capability of image forming apparatuses and PCs in recent years, it has become possible that outputs of a mainframe are printed by an electrophotographic image forming apparatus.

Thus, output-related environments of mainframes have diversified and improved the quality. Meanwhile, many of the output results of a mainframe are calculation results obtained by using business application programs and highly confidential in many cases, and therefore, in terms of information leakage and the like, it is unfavorable to output a calculation result of a mainframe to an apparatus which is located in an environment where a third party who is unrelated to an output can freely acquire the output.

In accordance with the improved performance of image forming apparatuses and PCs and also prevalence of network infrastructure, a printer or the like that has been conventionally placed in a printer room or the like may be placed in an open space. Taking this into consideration, there is a growing need for protecting a printout from access by a third party.

In a case when a confidential printout is to be produced by an instruction from a PC, it is relatively easy to offer security for the printout. For example, PCs are usually identified by user names, user IDs, or the like. Accordingly, output data, with which an identifier for unique identification of an author is associated, is transmitted from a PC to an image forming apparatus. The image forming apparatus obtains information associated with the identifier using an integrated circuit (IC) card or the like, compares the identifier with the information for verification, and controls printing of the output data depending on a result of the comparison, thereby minimizing inconvenience that a printout may be acquired by a third party.

As for the mainframe, too, it is possible to modify business application software for security management of printouts. However, it has been non-economical, and has also been unrealistic, from the viewpoint of cost performance, to stop the use of business application software and to restrict the access to data that cause interruption and delaying of business-critical operations over a maintenance period to modify business application software only for the purpose of improving the security of printouts.

To resolve such a problem, a technique disclosed in Japanese Patent Application Laid-open No. 2010-26649 can be employed.

Disclosed in Japanese Patent Application Laid-open No. 2010-26649 is a data relay apparatus that includes a printer driver unit including a data parsing unit and a text-string extracting unit. The data parsing unit receives output data from a host computer, such as a mainframe, and parses the output data to obtain text data and data on the layout of texts. The text-string extracting unit analyzes an output result of the data parsing unit and extracts identification data, which is contained in the output data, for individually identifying a user who has instructed the host computer to output the output data. The printer driver unit produces print data by describing the output data in a page description language (PDL), describes, as a control code, the identification data in a non-printing area of the print data, and transfers the print data to an image forming apparatus.

With the configuration described above, the image forming apparatus obtains the identification data described in the non-printing area of the print data received from the data relay apparatus as the control code and also obtains another identification data through an external storage medium, thereby comparing the identification data with the other identification data for the verification. When the two identification data match each other, an image forming engine is activated to produce a printout. As a result, the image forming apparatus is able to control output from the image forming apparatus by using the external storage medium while keeping the identification data used for an individual identification of the author not shown on the printout.

It is thus possible to improve security of printouts using an image forming apparatus without modifying business application software of a host computer of the image forming apparatus and without stopping the host computer for maintenance. Security management of printouts of outputs from the host computer can be performed only by adding minimum equipment, such as the image forming apparatus and an interface device, and keeping the software configuration of the host computer in use.

Meanwhile, output results of a mainframe are generally produced by using business application software and, output results are often output on business forms with which other operations such as ordering and inventory control may be linked.

Conventionally, to link business form printouts with another operation, a person in charge of the linked operations has to read numerical values output on each form in a large volume of business forms and to input the numerical values from a terminal computer or the like to establish linkage with ordering, inventory management, and/or the like operation. However, input error in numerical values or the like is likely to occur because types and items printed on the business forms are considerably large in number.

In consideration of this, it is preferable to output numerical data or character data written on business form in a form of coding data, such as a standard barcode or Quick Response (QR) code (registered trademark) so that data for operations can be extracted from a large volume of printouts accurately and efficiently. Meanwhile, header/footer data may also be used as accompanying data of a printout. Sometimes, it is also required to obtain information about a creation or modification date, an author, and the like from the header/footer data and pass the information to a subsequent operation, such as business management.

It is possible to add encoded data to a business form printout by adding, to application software installed on the mainframe, a module that causes a barcode, a QR code, or the like to be output. However, modifying the application software of a mainframe by the addition of a module for passing an output to another related operation is expensive and causes interruption and delaying in business-critical operations due to an interruption of the business application software and a restriction in the data access over a maintenance period. It is also required to modify the application software so as to link to operations in response to various needs of customers. Accordingly, it is impracticable, in terms of cost performance, to stop, to perform maintenance, or to develop business application software of a mainframe only therefor.

To resolve such a problem, a technique disclosed in Japanese Patent Application Laid-open No. 2010-97588 can be employed.

Disclosed in Japanese Patent Application Laid-open No. 2010-97588 is a data relay apparatus including a printer driver unit that includes a text-string extracting unit, a text-string extracting unit, and a graphical user interface (GUI) creating unit. The text-string extracting unit retrieves trigger data instructing to perform an encoding process from a text area contained in output data output from a host computer, such as a mainframe, and obtains a data range subsequent to the trigger data. The encoded-data producing unit receives information in the data range obtained by the text-string extracting unit to produce encoded data. And the graphical user interface (GUI) creating unit specifies the encoding process. Then, the printer driver unit superimposes the encoded data on the output data, thereby producing print data.

In the data relay apparatus configured as described above, trigger data instructing to perform an encoding process is retrieved from a text area contained in output data output from a host computer, a data range subsequent to the trigger data is obtained, encoded data is produced based on information in the data range, and the encoded data is superimposed on the output data to produce print data, which is then transmitted to an image forming apparatus, thereby causing the image forming apparatus to perform printing adapted to the encoded data.

Thus, data in a range of a data attribute desired by a user, of the output data from the host computer, is efficiently converted to encoded data without modifying software configuration of the host computer, and accordingly, it is possible to cause an image forming apparatus to print the output data as desired by the user. For instance, when output data from a host computer contains data (e.g., confidential data) that is better not to be output, it is possible to print the data with the confidential data being masked.

However, the technique disclosed in Japanese Patent Application Laid-open No. 2010-26649 disadvantageously involves a great increase in cost because the data relay apparatus outputs print data to the image forming apparatus and causes the image forming apparatus to verify identification data, requiring that software for the verification be installed in each of the already-placed image forming apparatuses.

The technique disclosed in Japanese Patent Application Laid-open No. 2010-97588 is disadvantageous in that the data relay apparatus causes printing to be performed with data that is better not to be printed being masked, which makes it difficult to see content of the thus-masked data portion even when there arises the need for checking the content later. The technique is also disadvantageous in that a printing medium, such as sheets, can be wastefully consumed because printing is performed even when entire output data is masked.

### SUMMARY OF THE INVENTION

It is an object of the present invention to at least partially solve the problems in the conventional technology.

According to an aspect of the present invention, there is provided a data relay apparatus that includes a connecting unit that connects an information processing apparatus to an image forming apparatus so as to allow communication therebetween; a print control unit that receives output data from the information processing apparatus, produces print data based on the output data, and outputs the print data to the image forming apparatus; an information extracting unit that retrieves, from the output data, trigger data instructing execution of processing and extracts information within a preset data range subsequent to the trigger data; a setting unit that sets the data range according to an instruction from outside; a processing unit that executes the processing based on the trigger data retrieved by the information extracting unit and the information within the data range extracted by the information extracting unit; a log-information generating unit that generates log information about the processing executed by the processing unit; and a log-information output unit that outputs the log information generated by the log-information generating unit.

According to another aspect of the present invention, there is provided a print control method for a data relay apparatus that includes a connecting unit that connects an information processing apparatus to an image forming apparatus so as to allow communication therebetween; and a print control unit that receives output data from the information processing apparatus, produces print data based on the output data, and outputs the print data to the image forming apparatus. The print control method includes retrieving, from the output data, trigger data instructing execution of processing; extracting information within a preset data range subsequent to the trigger data; setting the data range according to an instruction from outside; executing the processing based on the trigger data retrieved at the retrieving and the information within the data range extracted at the extracting; generating log information about the processing executed at the processing; and outputting the log information generated at the generating.

According to still another aspect of the present invention, there is provided a computer program product including a non-transitory computer-readable medium including computer-readable program codes embodied in the medium for controlling a data relay apparatus. The data relay apparatus includes a connecting unit that connects an information processing apparatus to an image forming apparatus so as to allow communication therebetween, and a print control unit that receives output data from the information processing apparatus, produces print data based on the output data, and outputs the print data to the image forming apparatus. The program codes, when executed, cause a computer to perform retrieving, from the output data, trigger data instructing execution of processing; extracting information within a preset data range subsequent to the trigger data; setting the data range according to an instruction from outside; executing the processing based on the trigger data retrieved at the retrieving and the information within the data range extracted at the extracting; generating log information about the processing executed at the processing; and outputting the log information generated at the generating.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary network configuration of an image forming system including a data relay apparatus and an image forming apparatus according to an embodiment of the present invention;

FIG. 2 is a block diagram illustrating an exemplary hardware configuration of the data relay apparatus illustrated in FIG. 1;

FIG. 3 is a block diagram illustrating an exemplary software configuration of the data relay apparatus illustrated in FIG. 1;

FIG. 4 is a diagram illustrating an exemplary operation screen, which is displayed on a display illustrated in FIG. 2, providing an input field, from which settings on types of a log information process can be configured on an item-by-item basis;

FIG. 5 is a block diagram illustrating an exemplary hardware configuration of the image forming apparatus illustrated in FIG. 1;

FIG. 6 is a flowchart illustrating exemplary print control performed by the data relay apparatus illustrated in FIG. 3 according to the present invention;

FIGS. 7(a), 7(b) and 7(c) are diagrams explaining processes to be performed when trigger data detected by a text-string extracting unit illustrated in FIG. 3 has hit a print cancel condition or a print suspension condition;

FIGS. 8(a), 8(b), and 8(c) are diagrams describing output of log information from a log-information generating unit illustrated in FIG. 3; and

FIGS. 9(a), 9(b), and 9(c) are explanatory diagrams illustrating different exemplary log information pieces output from the log-information generating unit illustrated in FIG. 3.

### DETAILED DESCRIPTION OF THE PREFERRED EMBODIMENTS

Exemplary embodiments of the present invention will be concretely described below with reference to the accompanying drawings.

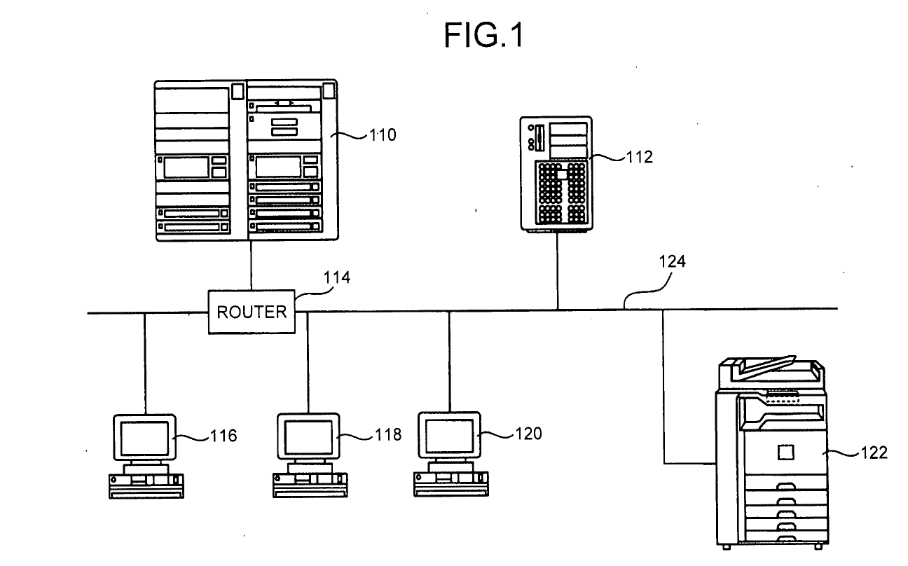

First, the configuration of an image forming system including a data relay apparatus and an image forming apparatus according to an embodiment of the present invention will be described with reference to FIG. 1.

FIG. 1 is a diagram illustrating an exemplary network configuration of the image forming system.

The image forming system (business operation system) is constructed for business-critical operations of an enterprise or the like, and is capable of performing processes by executing business application software. The image forming system includes a mainframe 110, which is a host computer, and a plurality of terminal computers 116, 118, and 120 that are connected to the mainframe 110 via a router 114 and a network 124, such as a local area network (LAN).

A data relay apparatus 112 is connected to the LAN 124. Upon receiving output data from the mainframe 110, the data relay apparatus 112 converts the output data into print data, and outputs (transmits) the print data to an image forming apparatus 122, to which the data relay apparatus 112 is connected via the network 124. In the present embodiment, the print data is data of a specific format, such as RAW data, that is processable by the image forming apparatus 122, and is output to the image forming apparatus 122 in a format processable by a general-purpose printer.

As the mainframe 110, although not limited, a business-oriented general-purpose computer can be used. The mainframe 110, on which a dedicated operating system is installed, executes business application software, thereby performing operations, such as database management, managing business forms, and creating business forms.

Each of the terminal computers 116, 118, and 120 is used by an input operator (user) to input various types of data, and allows the user to access the mainframe 110 by entering user-specific data such as a user ID and a password.

The mainframe 110 includes, in a management module, a user management database to control the user's access, via any of the terminal computers 116, 118, and 120, to the mainframe 110 and stores a user ID, a password, right of access, and the like in the user management database for each user name to perform user management.

The mainframe 110 can offer services to the terminal computers 116, 118, and 120 in a client-server style, for instance. The mainframe 110 can also serve as a web server that offers services to the terminal computers 116, 118, and 120 upon receipt of an operation request therefrom.

For this purpose, the mainframe 110 is utilizing a programming language, such as FORTRAN, Lisp, COBOL, PL/1, Pascal, C, C++, and Java (registered trademark), under the control of an appropriate operating system (OS), to allow the mainframe 110 to execute the business application software. When the mainframe 110 serves as a web server, the mainframe 110 may support a script language, such as Java (registered trademark), Perl, Ruby, and Python.

Each of the terminal computers 116, 118, and 120 is implemented in a PC or a workstation and provided with a single-core or multi-core central processing unit (CPU).

Each of the terminal computers 116, 118, and 120 includes random access memory (RAM), read only memory (ROM), a hard disk drive (HDD), and a network interface card (NIC) and can perform processes in association with the mainframe 110 on which an appropriate OS, such as Windows (registered trademark), UNIX (registered trademark), or LINUX (registered trademark) is running.

The data relay apparatus 112 can be implemented in a PC or a server. The data relay apparatus 112, on which an OS, such as UNIX (registered trademark), LINUX (registered trademark), Windows XP (registered trademark), Windows Vista (registered trademark), Windows 200× server (registered trademark), Solaris (registered trademark), or AIX is running, receives output data of the mainframe 110, produces print data in a format processable by the image forming apparatus 122, and passes the print data to the image forming apparatus 122. The data relay apparatus 112 has a user identifying function for identifying a user of the image forming apparatus 122 based on the identification data entered by the user through an external storage medium or the like.

Any type of data can be used as the identification data, examples of which include a user ID, a password, a user name, a company staff number, and a group identifier indicating a specific group. Any known input method can be used as a method for entering the identification data. Examples of the method include inputting the identification data with a numeric keypad, short-range communications with an external storage medium, such as an IC card or an IC tag, reading out data from an external storage medium, such as a secure digital (SD) card or a universal serial bus (USB) memory, and scanning a QR code or a barcode.

The data relay apparatus 112 is preferably implemented by, though not limited to, a PC, a server, or an appliance server on which the Windows is running because such implementation allows production of printouts in a WYSIWYG environment using a graphic display interface (GDI) and also has an advantage in the running cost, easy maintenance, and versatile use of software.

In a configuration in which the image forming apparatus 122 has a sufficient image forming capability, the data relay apparatus 112 can be configured as a functional module of the image forming apparatus 122, or connected via a peer-to-peer network to the image forming apparatus 122 so as to serve as a dedicated control device of the image forming apparatus 122.

The image forming apparatus 122 may be an MFP configured as so-called a network printer that receives the print data produced by the data relay apparatus 112 via the network 124. In addition to the MFP, the image forming apparatus 122 can be configured as a printer, such as a page printer or a laser printer, a digital copying machine, a facsimile machine, or the like.

The network 124 can be configured to include Ethernet (registered trademark) such as 1000Base-TX, an optical network, and a wireless network compliant with a standard, such as IEEE 802.11. Communications via the network 124 are carried out in frames or packets based on the Transmission Control Protocol/Internet Protocol (TCP/IP) protocol. The network 124 may be configured to include, in addition to LAN, a wide-area network, such as the Internet, in a secure environment using a virtual private network (VPN) or the like.

Next, operations to be performed by the mainframe 110 to transmit output data to the data relay apparatus 112 or the image forming apparatus 122 will be described below.

In the present embodiment, the mainframe 110 has a client function of File Transfer Protocol (FTP) and transmits output data to the data relay apparatus 112 or the image forming apparatus 122 using the FTP protocol, for instance. The output data of the mainframe 110 is line output data for printing by the image forming apparatus 122 (line printer or the like) and is described in a dedicated language used by the mainframe 110. Meanwhile, the data relay apparatus 112 has an FTP server function and identifies the output data of the mainframe 110 using the telnet protocol and performs processes according to the present invention.

A protocol for data transfer from the mainframe 110 to the data relay apparatus 112 allows frame transfer, file transfer using FTP, FTP Secure (FTPS), hypertext transfer protocol (HTTP), HTTP Secure (HTTPS) with the TCP/IP protocol, or the like according to the network protocol supported by the mainframe 110; the protocol can be appropriately set as required according to a network infrastructure implemented in the mainframe 110.

The mainframe 110 outputs, as the output data, business form data and the like that contains product name(s), model number(s), quantity, amount of money, and the like. In many cases, a printout printed on a paper medium based on the output data of the mainframe 110 is passed to another transaction; for instance, the printout may be delivered to a customer. If, for instance, an operator reads the amount of money, customer identification code, and/or the like data printed on the printout and input the data for the other transaction, typing error or the like can occur. There are some type of data, e.g., numerical data or departmental data printed on a business form printout, such as a pay slip or a detailed list of medical services covered by health insurance, that is preferably not directly recognizable to a third party.

Under these circumstances, the data relay apparatus 112 according to the present embodiment identifies and encodes information, such as a number sequence, a character sequence, indicating specific contents of business form data, thereby producing encoded data. The encoded data is, in place of the information, superimposed on the output data (in practice, intermediate data, into which the output data has been converted and which is interpretable by the image forming apparatus) to produce print data. The produced print data is transmitted through the network 124 to the image forming apparatus 122 to be printed by the image forming apparatus 122 and discharged therefrom as a printout.

Meanwhile, the mainframe 110 accesses the data relay apparatus 112 or the image forming apparatus 122 in normal situations with the access right of the administrator and requests the apparatus to perform various types of processes. Accordingly, the data relay apparatus 112 or the image forming apparatus 122 is unable to associate output data received from the mainframe 110 with its authoring user by referring to a sender address, sender's rights, or the like of the output data.

Accordingly, in a case when the image forming apparatus 122 or the like is not placed in a special-purpose room, such as a printer room, to which access is restricted, the output data from the mainframe 110 is output to the image forming apparatus 122 without restriction on the access to the output. If, in a condition where no printer room is provided, the image forming apparatus 122 placed in a general-purpose environment can obtain output data from the mainframe 110, it becomes possible to perform printing in a more general-purpose printing environment without a need to prepare a printer room or a special-purpose printer, and thereby, reduction in cost can also be achieved.

If a printed matter containing highly confidential information is directly output by an image forming apparatus, an unrelated third party can acquire the printed matter or access the output information. A trouble, such as loss of the printed matter, can occur, to lead to a problem that high security cannot be provided.

As described above, the mainframe 110 accesses an externally-connected apparatus with the right of the administrator; accordingly, printout of the output data cannot be produced by the control of the image forming apparatus 122 only by making use of the sender's address or an authority under transmission which is the only information added during the production process of the output data. Associating the authoring user with the output data created by the authoring user can be performed on the mainframe 110 by considering that the mainframe 110 performs access control using user management data. However, this requires that business application software be modified, which involves a maintenance period, modifying cost, and the like. Furthermore, the modification of the business application software needs to be performed by a manufacturer of the mainframe. In these respects, it is impracticable to modify the business application software only for improvement the security of printed matters.

For this reason, the data relay apparatus 112 has a function of inspecting output data output from the mainframe 110 and determining whether or not the output data contains identification data (identification data for uniquely identifying the user), such as a user ID of an operation user that has created the output data. A result of the determination as to whether or not the output data contains identification data is used in print control, which will be described later, as feedback.

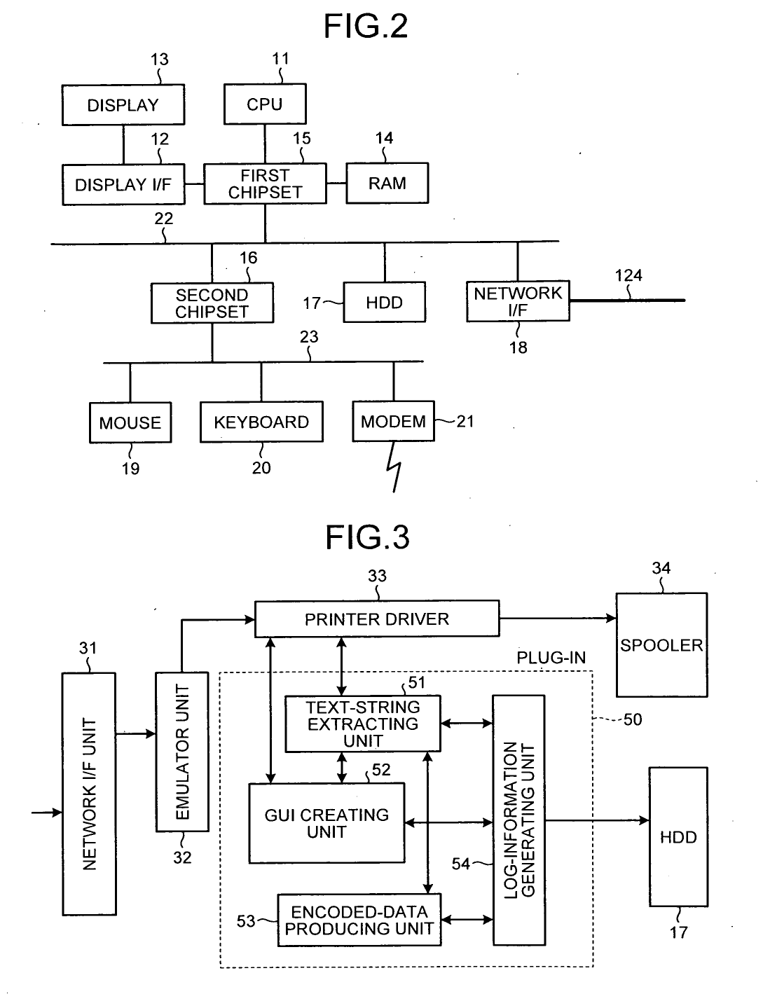

An exemplary hardware configuration of the data relay apparatus 112 illustrated in FIG. 1 will be concretely described with reference to FIG. 2.

FIG. 2 is a block diagram illustrating the exemplary hardware configuration of the data relay apparatus 112.

The data relay apparatus 112 includes a CPU 11, a display interface (I/F) 12, a display 13, RAM 14, a first chipset 15, a second chipset 16, an HDD 17, a network I/F 18, a mouse 19, a keyboard 20, and a modem 21.

The CPU 11 is a central processing unit that performs integrated control on whole of the data relay apparatus 112 according to various types of computer programs including a printer driver, which will be described later. The CPU 11 activates a plug-in unit so as to accept the printer driver, thereby serving as an information extracting unit, a setting unit, a processing unit, a log-information generating unit, and a log-information output unit according to the present invention.

The display I/F 12 outputs signals for displaying information on a status of the data relay apparatus 112 and the like by using the display (monitor) 13, which is an externally connected display unit, to a user.

The RAM 14 is a read/write memory used as a program memory into which computer programs executed by the CPU 11 are to be loaded, a working memory used by the CPU 11 to execute computer programs, a print data memory used in producing print data, and the like.

The first chipset 15 connects the CPU 11, the display I/F 12, and the RAM 14 to one another via a high-speed internal bus and carries out data exchanges through an external general-purpose bus 22.

The HDD 17, which is a memory device connected to the general-purpose bus 22, stores various computer programs including OS and the printer driver, various types of data, and the like.

The network I/F 18 is an interface for two-way communication with the image forming apparatus 122 via the network 124.

The first chipset 15, the HDD 17, and the network I/F 18 are connected to one another via the general-purpose bus 22, which is slower in the transfer speed than the internal bus.

The second chipset 16 carries out data exchange with the first chipset 15, the HDD 17, and the network I/F 18 and with ports through a further slower bus 23 than the general-purpose bus 22.

Each of a mouse port and a keyboard port receives an input (instruction) entered by a user action using, respectively, the mouse 19 or the keyboard 20, which is an externally connected input device (input unit). A modem port allows facsimile communications and the like on a telephone line (public line) connected to the external modem 21.

An exemplary software configuration of the data relay apparatus 112 illustrated in FIG. 1, or, more specifically, the printer driver installed on the data relay apparatus 112, the plug-in unit for accepting the printer driver, and computer programs related thereto, will be described below with reference to FIG. 3. In the present embodiment, descriptions will be made on an assumption that the data relay apparatus 112 employs Windows (registered trademark) architecture as the OS. However, the OS of the data relay apparatus 112 is not limited thereto, and any other OS can be used as the OS of the data relay apparatus 112 insofar as the other OS is capable of providing the same functions by using an appropriate emulation program.

FIG. 3 is a block diagram illustrating the exemplary software configuration of the data relay apparatus 112 illustrated in FIG. 1. For convenience of description, a process and process control that is performed in practice by the CPU 11 according to a computer program, such as the printer driver (print control program), is described below as being performed by the computer program. The same goes for other descriptions below in each of which a computer program is described as performing some operation or process control.

On the data relay apparatus 112, in addition to a network I/F unit 31 that is a computer program for receiving output data from the mainframe 110 through the network I/F 18 illustrated in FIG. 2, an emulator unit (emulation program) 32 that is a computer program for producing print data based on the output data received through the network I/F 18 and the network I/F unit 31, which form a connecting unit, a printer driver 33, and an encoding unit 50 corresponding to a plug-in unit for accepting the printer driver 33.

The data relay apparatus 112 obtains output data from the mainframe 110 through the network 124 using a communication protocol, such as the FTP protocol. The output data is received by the network I/F unit 31 and buffered (stored) in a buffer memory, such as a first-in, first-out (FIFO) buffer (not shown) that is managed by the emulator unit 32. A portion of a memory area of the RAM 14 illustrated in FIG. 2 can be used as the buffer memory.

The emulator unit 32 also combines text data with form data, thereby producing intermediate data interpretable by the image forming apparatus 122. After producing the intermediate data, the emulator unit 32 creates a GDI instance serving as a rendering component, calls the printer driver 33, and passes the produced intermediate data to the printer driver 33. The emulator unit 32 produces the intermediate data by obtaining output format data from the output data, determining character spacing, the number of lines, side margins, positions of data fields, font sizes, font designation, and the like and placing the text data in the specified format.

To perform the operation described above, the emulator unit 32 includes at least a data parser, a font-conversion processing unit, and a frame-conversion processing unit.

The emulator unit 32 buffers the output data received through the network I/F unit 31 in the buffer memory, such as the FIFO buffer. The emulator unit 32 analyzes a format, which is used by the mainframe 110, of the output data, separates a frame for obtaining a text portion and creating a business form, and modifies the format to a format used by the data relay apparatus 112. The modification of the format includes font change, changing print margins of the text portion, determination and acquisition of a form image, and size adjustment of the form image.

The emulator unit 32 identifies a dedicated language used by the mainframe 110 and parses line output data to associate the line output data to a command system interpretable by the data relay apparatus 112.

For this purpose, the data parser has a table, with which association with dedicated-language commands can be established. The operation performed by the data parser can be implemented by using a conventional language conversion method using a compiler, an interpreter, or the like.

The font-conversion processing unit manages a font mapping table for associating a font used by the mainframe 110 to a corresponding font of the data relay apparatus 112. The font-conversion processing unit converts the font of the output data from the mainframe 110 to the corresponding font of the data relay apparatus 112. When an image, such as a logo, that is not managed by the data relay apparatus 112 is detected, the font-conversion processing unit creates a corresponding bitmap image or the like and associates the image with the intermediate data.

The frame-conversion processing unit obtains data in an area designated by the data parser as an area describing frame data, obtains a frame image associated with the data, and associates the frame image with the intermediate data. Alternatively, the frame-conversion processing unit obtains frame data, creates a corresponding frame image on-the-fly, and associates the frame image with the intermediate data.

When production of the intermediate data has completed, the emulator unit 32 creates a GDI instance and calls the printer driver 33 and the encoding unit 50, causing print control to start.

The printer driver 33 causes processes of producing print data and transmitting the print data to the image forming apparatus 122. When the emulator unit 32 creates the GDI instance, the printer driver 33 obtains the intermediate data as data to be processed, analyzes a text area of the intermediate data, and determines whether or not the text area contains trigger data to be used. If it is determined that the text area contains trigger data, the printer driver 33 obtains information contained in a data range (information in the data range) that is preset (pre-specified) by an external instruction caused by a user action (instruction by operation of an input device by the user, which is hereinafter called a user's instruction) subsequent to the trigger data and that is has been set by the user's instruction. The printer driver 33 further performs processes, including an encoding process to produce encoded data based on the information in the data range, according to the present invention.

The encoded data means a minimum set of data that can be decoded by decoding. Encoded data is superimposed to a two-dimensional image as decodable numerals or the like. The encoded data can be an image data containing only encoded data, or the encoded data can be an encoded image containing an encoded image and background data used for size adjustment.

Alternatively, the encoded data can be configured as image data (hereinafter, “masking image”) that masks a specific area of a printout produced by the image forming apparatus 122 to thereby hide highly-confidential information of a confidential document or the like. The masking image is created based on information, about a masking-image area, contained in the data range subsequent to the trigger data.

Furthermore, encoded data can be produced by a process of producing rendering data, such as PDL, that can be rendered and rendering the rendering data on an appropriately-sized background image or the like. In any case, to superimpose the encoded data on the intermediate data, a process of superimposing the encoded data on an area corresponding to the trigger data and the data range is performed. Production of the encoded data will be described in detail later.

To perform the operations described above, the printer driver 33 includes, in addition to a general-purpose processing module that produces print data from intermediate data, the encoding unit 50 that is capable of processing depending on the contents of the text data. The encoding unit 50 can be provided as a plug-in unit for accepting the printer driver 33 or as a function enhancement module for the already-installed printer driver 33. The encoding unit 50 includes a text-string extracting unit 51, a GUI creating unit 52, an encoded-data producing unit 53, and a log-information generating unit 54 that allow the encoding unit 50 to serve as the units according to the present invention.

The text-string extracting unit 51, corresponding to the information extracting unit, extracts text data from a text area in the intermediate data. Unless detecting (retrieving) trigger data, the text-string extracting unit 51 immediately returns the text data to the printer driver 33, causing the text data to be buffered. Upon detecting trigger data, the text-string extracting unit 51 obtains the trigger data and a pre-specified (preset) data range subsequent to the trigger data, and extracts information in the preset data range subsequent to the trigger data from data in the (trigger data+data range) range.

After extracting the information in the pre-specified data range subsequent to the detected trigger data, the text-string extracting unit 51 passes the information to the encoded-data producing unit 53. A targeted text area, which can be a target for encoding, is not specifically limited; examples of the targeted text area include, in addition to the body of the text document, a number sequence assigned to a header or footer, a character sequence, and any sequence that is a combination of these sequences.

The text-string extracting unit 51 also determines whether or not the intermediate data contains identification data.

Upon obtaining the information in the data range extracted by the text-string extracting unit 51, the encoded-data producing unit 53 calls an encoder (not shown) and causes the encoder to encode the obtained information in the data range. Similarly to other functional processing elements, the encoder can be implemented as a plug-in unit and, accordingly, any known encoding programs can be used. This encoder encodes the obtained information in the data range according to the standard, such as the Japan Article Number (JAN)-13, the JAN-8, the Interleaved 2 of 5 (ITF), the Standard 2 of 5 (STF), the NW-7 (CORDAVAR, panacode), the Code 39, the Code 128, the GS1-128, the UCC/EAN 128, a barcode for a settlement of public utility charges at a convenience store, the GS1 Databar Ominidirecitonal (RSS-14 truncated), or the GS1 Databar Limited (RSS-14 limited). In a case in which the obtained information in the data range contains information other than numerical data, the encoder can be a software module that converts the information into a two-dimensional barcode, such as the QR code.

The log-information generating unit 54 has functions of a log-information generating method and a log-information output method. When a process that cancels or suspends printing or the encoding process (including a masking processing) necessary for printing is performed, the log-information generating unit 54 generates log information (historical information) about the process and outputs the log information.

The encoded data produced by the encoding unit 50 is temporarily buffered, and thereafter returned to the printer driver 33 depending on a process performed by the printer driver 33.

Upon receiving the encoded data from the encoding unit 50, the printer driver 33, which has buffered the intermediate data, adjusts the size of the encoded data to a size adapted to an additional area of the encoded data so that the encoded data corresponds to the (trigger data+data range) are of the intermediate data, and superimposes the encoded data onto the area corresponding to the (trigger data+data range) (before the final information in the (trigger data+data range) area). Size adjustment of the encoded data will be described in detail later.

After superimposing the encoded data, the printer driver 33 adds a PDL command for controlling the image forming apparatus 122 as appropriate. Thereafter, the printer driver 33 passes the intermediate data to a spooler 34, and causes the spooler 34 to produce RAW data used by a general-purpose printer and transmit the print data to the image forming apparatus 122 designated via a port monitor.

Meanwhile, the encoded-data producing unit 53 can create, as the encoded data, a masking image that is to be superimposed on print data by using the information in the data range, which will be described later, in the trigger data. Specifically, the encoded-data producing unit 53 creates a masking image of a size specified by the information in the data range and buffers the masking image. The printer driver 33 superimposes the masking image created by the encoded-data producing unit 53 on the intermediate data with respect to a position, serving as an origin, of the masking image specified in the information in the data range.

The GUI creating unit 52 can provide the GUIs according to the ways (1) to (3) described below when a user with an administrator authority logs in the data relay apparatus 112. Provision of the GUI is selectively performed by the user's instruction.

(1) A GUI for setting identification data is provided. That is, an operation screen (dialog box) that provides an input field where identification data, such as a user ID, can be set is displayed on the display 13.

When the operation screen is displayed, identification data is entered in the input field by the user's instruction. The printer driver 33 configures setting of the thus-input identification data and stores the setting (the identification data having been set) in the HDD 17. Detailed description about such identification data setting is omitted; however, identification data setting can be performed in a similar manner as that described in Japanese Patent Application Laid-open No. 2010-26649.

(2) A GUI for condition settings by the encoding unit 50 in performing the encoding process is provided. That is, an operation screen providing an input field where conditions related to the encoding process can be set is displayed on the display 13 illustrated in FIG. 2. The condition settings include setting as to whether or not the encoding unit 50 performs the encoding process, setting on trigger data when the encoding unit 50 performs the encoding process, setting on sizing of data for the encoded image, and setting on the data range subsequent to the trigger data.

When the operation screen that provides the input field where the conditions related to the encoding process can be set is displayed, condition settings are specified in the input field by the user's instruction. The printer driver 33 configures settings according to the specified condition settings and stores the settings in the HDD 17. When the encoding process is the masking processing (masking), condition settings related to the masking processing, such as designation as to whether or not the masking processing is to be performed, setting on trigger data in performing the masking processing, and settings on location (a starting point, a center point, and the like) and a size of a masking image, can be configured. Detailed description about such condition settings related to the encoding process is omitted; however, condition settings can be performed in a similar manner as that described in Japanese Patent Application Laid-open No. 2010-97588.

(3) A GUI to set conditions for the log-information generating unit 54 to perform a process related to log information is provided. That is, an operation screen providing an input field to specify the log information process types on an item-by-item basis is displayed on the display 13.

When the operation screen providing the input field to set the log information process types on the item-by-item basis is displayed, settings, by user's instruction in the input field, on the log information process types are specified on the item-by-item basis. Then the printer driver 33 configures the specified settings and stores the settings in the HDD 17.

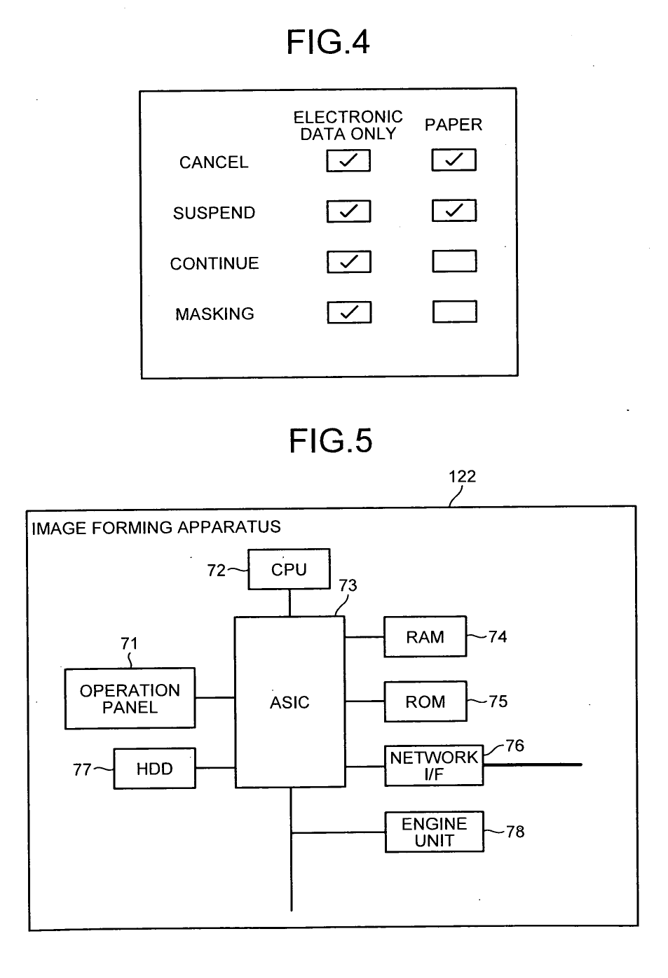

FIG. 4 is a diagram illustrating an exemplary operation screen, which is displayed on the display 13 illustrated in FIG. 2, providing the input field where the log information process types can be set on the item-by-item basis.

In this example, the items include “CANCEL” indicating a process that cancels printing, “SUSPEND” indicating a process that suspends printing, “CONTINUE” indicating a process that continues printing, and “MASKING” indicating the masking processing.

The log information process types include “ELECTRONIC DATA ONLY” indicating a process that outputs (stores) log information to the HDD 17 and “PAPER” indicating a process that causes log information to be output (printed) on paper (or other printing medium). Selection of the type can be made by inputting a checkmark in the input field displayed on the display 13.

FIG. 4 illustrates an example where, when the process that cancels printing is performed, log information about this process is output to the HDD 17 and also output on a sheet. Also when the process that suspends printing is performed, log information about this process is output to the HDD 17 and also output on a sheet. When the process that continues printing is performed, log information about this process is output to the HDD 17. Also when the masking processing is to be performed, log information about this process is output to the HDD 17.

A configuration, in which a command corresponding to the input select is transmitted to the print requester, can be employed so that the operation screen providing a corresponding one of the input fields described above is displayed on each display of the terminal computers 116, 118, or 120. With this configuration, in a case in which the terminal computer, which is the print requester, has received the command and the operation screen providing the input field is displayed on the terminal computer (it is assumed that a computer program for displaying the operating screen has been installed on the terminal computer), when various settings are specified in the input field, a corresponding command is transmitted to the data relay apparatus 112. Thus, the printer driver 33 can receive the command and configure corresponding settings. If the data relay apparatus 112 includes a non-volatile storage unit, such as a flash memory, other than the HDD 17, the settings can be stored in the non-volatile storage unit.

An exemplary hardware configuration of the image forming apparatus 122 illustrated in FIG. 1 will be concretely described with reference to FIG. 5.

FIG. 5 is a block diagram illustrating the exemplary hardware configuration of the image forming apparatus 122 illustrated in FIG. 1.

The image forming apparatus 122 includes an operation panel 71, a CPU 72, an application specific integrated circuit (ASIC) 73, RAM 74, ROM 75, a network I/F 76, an HDD 77, and an engine unit 78. Of these elements, the CPU 72, the ASIC 73, the RAM 74, the ROM 75, the network I/F 76, and the HDD 77 form a controller, which is an image processing apparatus that produces image data to be printed.

The operation panel 71 is an operation unit that includes various control keys (each of which is referred to as a control switch or a control button) used in entering operation requests (print request, transmission request, and the like) to the engine unit 78 and an external device by a user action, and a display device, such as a liquid crystal display (LCD) or a cathode ray tube (CRT).

The CPU 72 is a central processing unit that performs integrated control on the whole of the image forming apparatus 122 according to computer programs. The CPU 72 is capable of controlling built-in modules included in the CPU 72 and inputs/outputs of various devices connected to the CPU 72 via the ASIC 73 and executing printer application programs for printing operations performed by the engine unit 78, which will be described later.

The ASIC 73 is a multifunctional device board that includes a plurality of I/Fs and the like for connecting the operation panel 71, the CPU 72, the RAM 74, the ROM 75, the network I/F 76, and the HDD 77 to one another; the ASIC 73 is an IC for shared use of devices that are to be controlled by the CPU 72 and supporting efficiency enhancement of development of application programs and the like in terms of architecture. In this example, the ASIC 73 includes hardware elements for image processing.

The RAM 74 is read/write memory (storage unit) used as a program memory that stores computer programs to be executed by the CPU 72, a working memory used by the CPU 72 to execute computer programs, an image memory to be used by the engine unit 78 to store image data when printing a visible image on a sheet according to print data, and the like.

The ROM 75 is a read only memory that stores various computer programs and data for performing image processing and various controls including print control.

The network I/F 76 is an interface for receiving print data from the data relay apparatus 112 via the network 124.

The HDD 77 is an auxiliary storage device (storage unit) that stores an OS used by the image forming apparatus 122, computer programs for performing controls according to the present invention, various data pieces including print settings (in practice, data representing the print settings), and various computer programs including a printer driver to be used by the data relay apparatus 112 and a plug-in unit for accepting the printer driver.

The engine unit 78 includes, to implement a printing function, a plotter (image forming unit) that outputs, by printing, an image on a sheet based on image data (print rendering data) by an image forming method using a laser, a light-emitting diode, an ink-jet method, and the like. In a case in which FIG. 5 illustrates a configuration of an MFP, the engine unit 78 should include a scanner and the plotter to implement a scanner function and a copier function.

In the image forming apparatus 122 configured as described above, the CPU 72 executes computer programs to implement various functions including a function as a transmitting unit according to the present invention. When, for instance, an acquisition request for the printer driver or the plug-in unit for accepting the printer driver is issued from the data relay apparatus 112, or a request for transmitting the printer driver or the plug-in unit for accepting the printer driver to the data relay apparatus 112 is issued from an input device, the printer driver or the plug-in unit for accepting the printer driver can be transmitted to the data relay apparatus 112, which issued the acquisition request of or which is the destination of the printer driver or the plug-in unit according to the transmission request. Upon receiving the printer driver or the plug-in unit for accepting the printer driver, the data relay apparatus 112 stores it in the HDD 17 illustrated in FIG. 2.

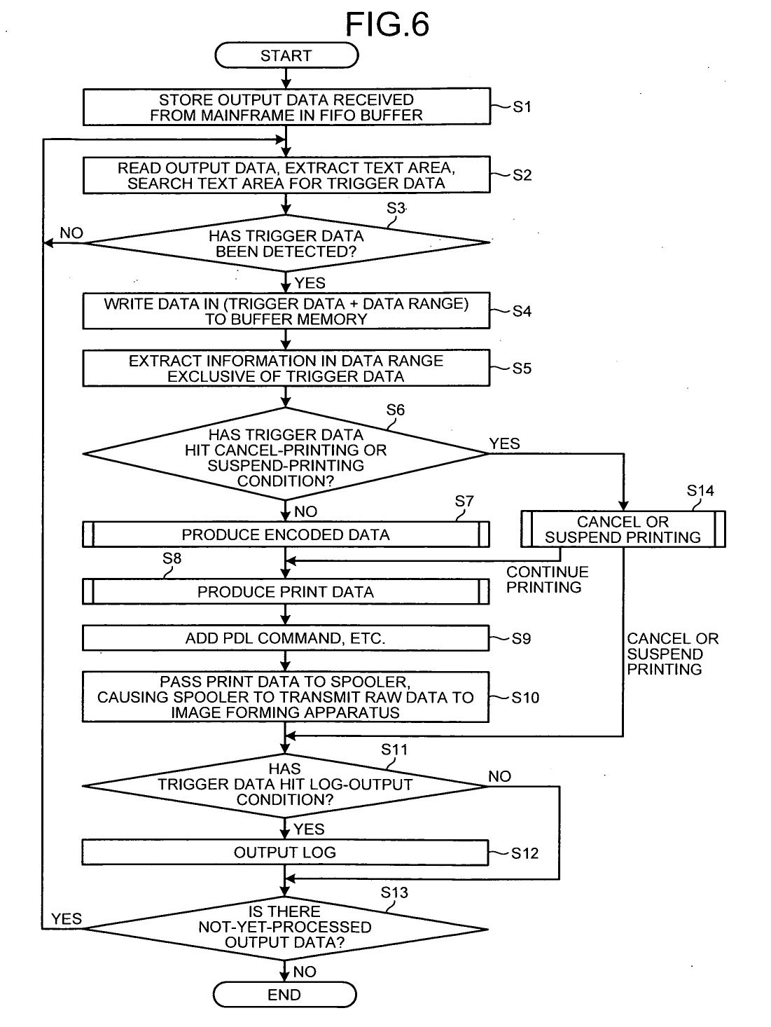

The print control process in the image forming system configured as above according to the present invention will be described with also reference to FIGS. 6 to 9. For convenience of description, description about processes to be performed by the emulator unit 32 is mostly omitted.

FIG. 6 is a flowchart illustrating exemplary print control process performed by the data relay apparatus 112 illustrated in FIG. 3 according to the present invention.

In the data relay apparatus 112, upon receiving output data from the mainframe 110, the printer driver 33 starts the print control process illustrated in FIG. 6; first, the output data received from the mainframe 110 at step S1 is stored in the FIFO buffer.

Next, at step S2, the output data is read out from the FIFO buffer in a first-in-first-out manner; the text-string extracting unit 51 reads a text area in the thus-read output data (in practice, intermediate data converted by the emulator unit 32) to search trigger data in the text area. At step S3, it is determined whether or not the trigger data has been detected. If no trigger data has been detected, the print control process returns to step S2 to continue to search trigger data.

If trigger data has been detected at step S3, the print control process proceeds to step S4 where string information from the trigger data to a final code (final information) in a preset data range is read and written to (buffered in) the buffer memory. Although not illustrated in FIG. 6, after the string information in the (trigger data+data range) has been obtained, the text area is returned to the printer driver 33. Furthermore, it is determined whether or not the output data having been read out contains identification data (user ID or the like). If it is determined that the output data contains identification data, the identification data is also written to the buffer memory. Specific descriptions about processes related to identification data, such as the determination as to whether or not output data contains identification data, are omitted; however, the processes can be performed similarly to those described in Japanese Patent Application Laid-open No. 2010-26649.

Next, the print control proceeds to step S5 where the text-string extracting unit 51 extracts string information exclusive of the trigger data because information desired by a user is limited to string information in the data range, which is a part of string information in the trigger data and the data range. Although not illustrated, null character codes (null character information) with the number corresponding to the string information from the trigger data to the final code in the data range are added to the string information, and the string information, to which the null character codes are added, is returned to the printer driver 33. As a result, corresponding portions in the text area are substituted by the null character codes. Consequently, the size of the encoded data is adjusted to a size of the information from the trigger data to the final code in the data range.

The text-string extracting unit 51 can also return to the printer driver 33 the text area, on which no operation has been done by the text-string extracting unit 51. This method can be appropriately applied to producing an encoded data by converting code data into an image form, and superimposing an opaque background of an adequate background size on the (trigger data+data range) of the image, thereby hiding character codes in an area corresponding to the (trigger data+data range).

At subsequent step S6, the text-string extracting unit 51 determines whether or not the detected trigger data has hit any one of a print cancel condition and a print suspension condition. If there is no hit, the print control proceeds to step S7 where, according to an instruction received from the text-string extracting unit 51, the encoded-data producing unit 53 passes the string information in the data range extracted by the text-string extracting unit 51 to the encoder to cause the string information to be encoded, thereby producing encoded data. The encoded data can be produced in a form of image data; alternatively, the encoded data can be registered as a file (e.g., a font file) with which encoded data is to be produced using an appropriate rendering command.

At subsequent step S8, according to an instruction received from the text-string extracting unit 51, the printer driver 33 produces print data.

Specifically, the printer driver 33 combines character data contained in the output data with form data obtained from the output data. Then, the printer driver 33 combines the encoded data with the character data and the form data while positioning the encoded data resized to fit the (trigger data+data range) area, thereby producing the print data.

In a case in which the trigger data detected by the text-string extracting unit 51 is data instructing to perform the masking processing, the encoded-data producing unit 53 creates, at step S7, a masking image of a size specified by the string information in the data range extracted by the text-string extracting unit 51 as encoded data, and at step S8, according to an instruction received from the text-string extracting unit 51, the printer driver 33 superimposes the masking image created as the encoded data on the output data (intermediate data) with respect to a position of the masking image specified in the information on the data range, thereby producing print data. Detailed descriptions on the production of the encoded data and the print data are omitted; however, the encoded data and the print data can be produced by a method similar to that described in Japanese Patent Application Laid-open No. 2010-97588.

At subsequent step S9, the printer driver 33 adds a PDL command and the like to the produced print data according to settings.

At subsequent step S10, the printer driver 33 passes the print data (combined data), to which the PDL command has been added, to the spooler 34, causing the spooler 34 to produce RAW data and transmit the RAW data via the port monitor to the image forming apparatus 122 and causes the image forming apparatus 122 to perform printing. On a printed matter (printout) produced by the printing, the user-specified data range of the output data from the mainframe 110 is presented in the form of the encoded data, by which operation efficiency of subsequent transactions that utilize the printout is improved.

If the text-string extracting unit 51 has determined at step S6 that the detected trigger data has hit any one of the print cancel condition and the print suspension condition, the print control process proceeds to step S14.

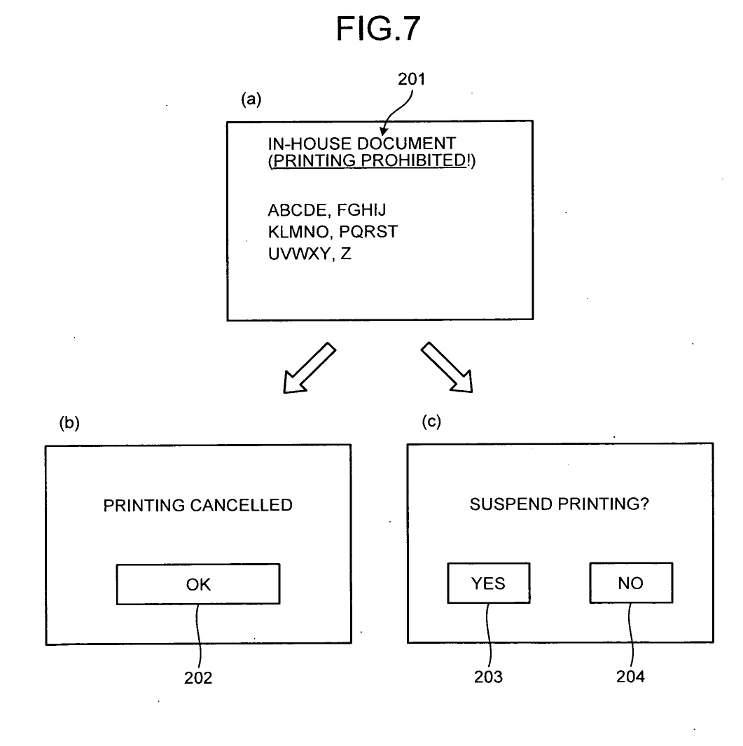

Meanwhile, when, for instance, the output data contains document data, which is illustrated in FIG. 7(a) and in which “PRINTING PROHIBITED” has been set as trigger data 201, it is determined that the detected trigger data has hit the print cancel condition or the print suspension condition.

That is, if it has been determined that the output data contains no identification data, it is determined that the detected trigger data has hit the print cancel condition. If it has been determined that the output data contains identification data, a determination as to whether or not the identification data matches preset identification data (administrator authority stored in the HDD 17 or the like identification data) is made; even when the identification data does not match, it is still determined that the detected trigger data has hit the print cancel condition, whereas if the identification data has matched the preset identification data, it is determined that the detected trigger data has hit the print suspension condition.

At step S14, the text-string extracting unit 51 performs a process that cancels or suspends printing.

More specifically, if it has been determined that the detected trigger data has hit the print cancel condition, the GUI creating unit 52 is caused to display, as a message confirming that printing is to be canceled, an operation screen including an information message “PRINTING CANCELED” indicating that printing is to be canceled and an “OK”button 202 on the display 13 as illustrated in FIG. 7(b), for instance. Thereafter, if the “OK” button 202 is selected by a user action, an affirmative response indicating acceptance of print cancellation is provided. Accordingly, the output data containing the detected trigger data is deleted by the printer driver 33, and printing to be performed by the image forming apparatus 122 is canceled. The print control process then proceeds to step S11.

If it has been determined that the detected trigger data has hit the print suspension condition, the GUI creating unit 52 is caused to display an operation screen including an information message “SUSPEND PRINTING?” asking whether or not to suspend printing, a “Yes” button 203, and a “No” button 204 on the display 13 as illustrated in FIG. 7(c), for instance, as a message asking whether or not to suspend printing. Thereafter, if the “Yes” button 203 is selected by a user action, an affirmative response indicating acceptance of print suspension is provided. Accordingly, the output data containing the detected trigger data is deleted by the printer driver 33, and printing to be performed by the image forming apparatus 122 is suspended. The print control process then proceeds to step S11. If the “No” button 204 is selected by a user action, a negative response indicating denial of print suspension is provided. Accordingly, the print control process proceeds to step S8 where the process, which is necessary for normal printing, that produces print data from the output data containing the detected trigger data is continued by the printer driver 33.

In order to cause the operation screen, including the message confirming that printing is to be canceled or the message asking whether or not to suspend printing to be displayed on the display of the terminal computer 116, 118, or 120, which is a print requester, a corresponding command can be transmitted to the print requester. When the terminal computer, which is the print requester, has received the command and the operation screen is displayed on the terminal computer (it is assumed that a computer program for displaying the operating screen has been installed on the terminal computer), in response to an operation performed on the operation screen, a corresponding command is transmitted to the data relay apparatus 112. Accordingly, the text-string extracting unit 51 can receive the command and perform a corresponding process.

At subsequent step S11, according to an instruction received from the text-string extracting unit 51, the log-information generating unit 54 determines whether the trigger data (specific keyword) detected by the text-string extracting unit 51 has hit a log-information output condition. If it is determined that there has been a hit, the print control process proceeds to step S12, whereas if there is no hit, the print control process proceeds to step S13. In the example illustrated in FIG. 4, when a process that cancels or suspends printing, or the masking processing is performed, it is determined that the trigger data detected by the text-string extracting unit 51 has hit the log-information output condition.

At step S12, log information about any one of the process that cancels printing, the process that suspends printing and the masking processing is output because the process is performed.

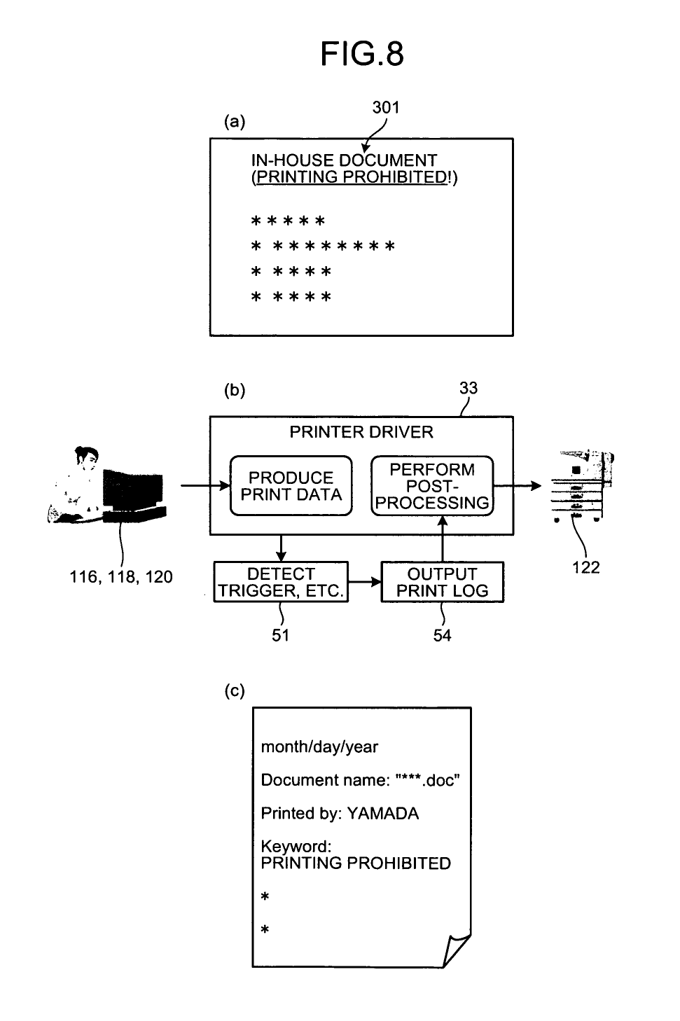

In a situation in which, for instance, output data of the mainframe 110 that is output in response to a print request issued from the terminal computer 116, 118, or 120 contains document data illustrated in FIG. 8(a) and “PRINTING PROHIBITED” has been set as trigger data 301 in the document data, when the text-string extracting unit 51 detects the trigger data 301 (PRINTING PROHIBITED) while print data is being produced by the printer driver 33, the process that cancels or suspends printing is performed as illustrated in FIG. 8(b). Accordingly, during postprocessing performed by the printer driver 33, the log-information generating unit 54 determines that the trigger data 301 detected by the text-string extracting unit 51 has hit the log-information output condition, and outputs log information about the process that cancels or suspends printing as illustrated in FIG. 8(c). The log information indicates each of day/month/year (hour may be included) when the process has been performed, a document name corresponding to the identification data of the print data, a name of a printing person corresponding to the user, and a specific keyword corresponding to the trigger data.

It is preferable to output the log information about the process that cancels or suspends printing or the masking processing to the image forming apparatus 122 to cause the log information to be printed by the image forming apparatus 122, to the display 13 illustrated in FIG. 2 to cause the log information to be displayed on the display 13, or to the HDD 17 to cause the log information to be stored in the HDD 17. Alternatively, the log information can be transmitted to the terminal computer 116, 118, or 120, which is the print requester, to cause the log information to be displayed on the display of the terminal computer 116, 118, or 120. At log-in of a user having an administrator authority to the data relay apparatus 112, the log information stored in the HDD 17 can be output, on user's instruction, to the image forming apparatus 122 to be printed or to the display 13 to be displayed, or transmitted to the terminal computer 116, 118, or 120, which is the print requester, to be displayed on its display. If the data relay apparatus 112 includes a non-volatile storage unit, such as a flash memory, other than the HDD 17, the log information can be stored in the non-volatile storage unit.

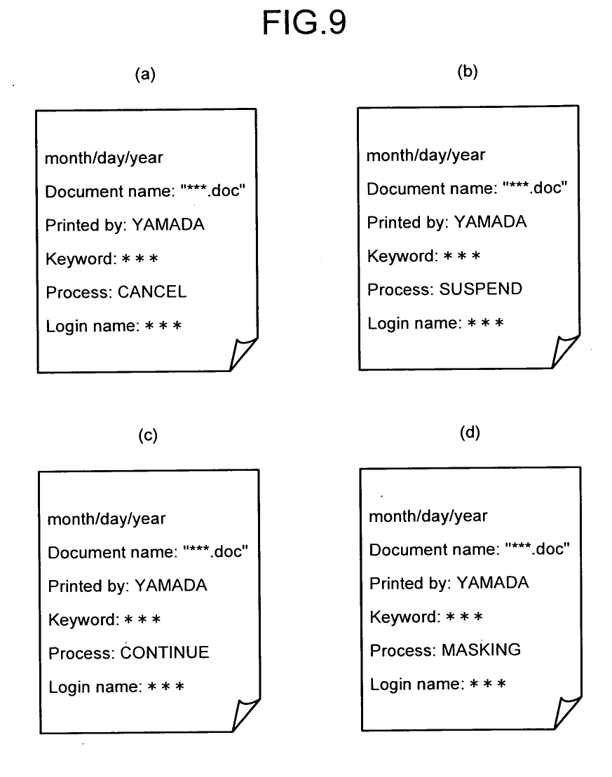

Types of the log information about the process that cancels or suspends printing other than the log information illustrated in FIG. 8(c) include those illustrated in FIGS. 9(a), 9(b), and 9(c). The log information, which is one of the other types, illustrated in FIG. 9(a) is output after the “OK” button 202 in the operation screen illustrated in FIG. 7(b) has been selected and the process that cancels printing has been performed. The log information illustrated in FIG. 9(b) is output after the “Yes” button 203 in the operation screen illustrated in FIG. 7(c) has been selected and the process that suspends printing has been performed. The log information illustrated in FIG. 9(c) is output after the “No” button 204 in the operation screen illustrated in FIG. 7(c) has been selected and the process that continues printing has been performed.

The log information illustrated in FIG. 9(d) is another type of the log information about the masking processing. Each of the log information pieces illustrated in FIGS. 9(a), 9(b), 9(c), and 9(d) indicates the date when the process that cancels, suspends, or continues printing or the masking processing has been performed, a document name corresponding to a name of the print data, a name of a printing person corresponding to the user that has requested printing, a specific keyword corresponding to the trigger data, the process performed, and a login name corresponding to the identification data (user ID) contained in the output data (intermediate data). Meanwhile, information indicating contents of data at a position to be masked by the masking image can be generated and contained in the log information about the masking processing.

Referring back to the print control process illustrated in FIG. 6, at step S13, the printer driver 33 determines whether or not not-yet-processed output data is in the FIFO buffer. If there is no not-yet-processed output data, the print control process illustrated in FIG. 6 ends. If there is any not-yet-processed output data, the print control process returns to step S2, and the operations described above are repeatedly performed until no not-yet-processed output data remains in the FIFO buffer.

As described above, the data relay apparatus receives output data from the mainframe, produces print data based on the output data, and outputs the print data to the image forming apparatus. While the print data is produced, trigger data instructing to perform a process is retrieved from the output data and information in a preset data range subsequent to the trigger data is extracted from the output data. The process is performed based on the retrieved trigger data and the extracted information in the data range. Log information about the process is generated and output. Accordingly, a user can obtain desired information (a reason why printing has been canceled or suspended, contents of masked data portion, and the like) about a result of printing performed by the image forming apparatus by accessing the log information. Thus, it is possible to improve security of output data from a mainframe while responding to user demands without increasing cost.

Advantages (1) to (5) described below can also be obtained.

(1) The log information may be output to an image forming apparatus to be printed or output to a display to be displayed. The resultant printout or display allows a user to see the contents of the log information easily.

(2) The log information may be output to and stored in a storage unit, such as an HDD, so that the log information is output from the storage unit according to an instruction from outside. This allows, whenever necessary, accessing the contents of the log information.

(3) When the retrieved trigger data has hit a print cancel condition, the output data containing the trigger data is deleted, and printing to be performed by the image forming apparatus is canceled. This prevents wasteful consumption of paper, thereby leading to paper saving.

(4) When the retrieved trigger data has hit the print cancel condition, a message confirming that printing is to be canceled is displayed. If, to the message displayed, an affirmative response indicating acceptance of print cancellation is received from outside, the output data containing the trigger data is deleted, and printing to be performed the image forming apparatus is canceled. In addition to an effect similar to that of (3), this allows a user to confirm that printing is to be canceled, so that usability for the user can be improved.

(5) When the retrieved trigger data has hit a print suspension condition, a message asking whether or not to suspend printing is displayed. If, to the message displayed, an affirmative response indicating acceptance of print suspension is received from outside, the output data containing the trigger data is deleted, and printing to be performed the image forming apparatus is suspended. If a negative response indicating denial of print suspension is received from outside, the process that is necessary for normal printing in producing print data from the output data is continued. In addition to an effect similar to that of (3), this allows a user to confirm that printing is to be suspended or continued, so that usability for the user can be further improved.

The embodiment has been described through the example where output data is received from the mainframe; however, similar advantages can also be obtained from a situation where output data is received from other information processing apparatus, such as a terminal computer.

The computer program according to the present invention is a print control program (corresponding to the plug-in unit for accepting the printer driver) for causing a computer (CPU) that controls the data relay apparatus to serve as the information extracting unit, the setting unit, the processing unit, the log-information generating unit, and the log-information output unit according to the present invention. By causing the CPU to execute the print control program, the advantages described above can be obtained. The print control program may be described in an object-oriented programming language or the like, such as assembler, C, Visual C, C++, or Java (registered trademark).

The print control program may be stored in ROM, non-volatile memory (e.g., flash ROM or electrically erasable programmable ROM (EEPROM)), or an HDD provided in the data relay apparatus in advance. Alternatively, the print control program may be provided as being recorded in a compact disc (CD)-ROM, which is a storage medium, or a non-volatile storage medium (memory), such as a memory card, a flexible disk, a magneto optical (MO) disk, a CD recordable (CD-R), a CD-rewritable (CD-RW), a digital versatile disc (DVD)+R, a DVD-RW, or a DVD-RAM. The steps described above can be carried out by installing the print control program stored in the above storage medium on the data relay apparatus and causing the CPU to execute the print control program, or causing the CPU to read the print control program from the storage medium and execute the print control program.

The print control program may be downloaded from an external device connected to a network and including a storage medium that stores the print control program or an external device including a storage unit that stores the print control program and may be executed.

According to an aspect of the present invention, a data relay apparatus (or a computer that controls the data relay apparatus) receives output data from an information processing apparatus, produces print data based on the output data, and outputs the print data to the image forming apparatus. While the print data is produced, trigger data instructing to perform a process is retrieved from the output data and information in a preset data range subsequent to the trigger data is extracted from the output data. The process (e.g., a process that cancels or suspends printing in response to a user request or a masking processing) is performed based on the trigger data and the information, while log information about the process is generated and output. Accordingly, a user can obtain desired information (a reason why printing has been canceled or suspended, contents of masked data portion, and the like) about a result of printing performed by the image forming apparatus easily by accessing the log information. Thus, it is possible to improve security of output data from the information processing apparatus while responding to user demands without increasing cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A data relay apparatus comprising:
a connecting unit that connects an information processing apparatus to an image forming apparatus so as to allow communication therebetween;
a print control unit that receives output data from the information processing apparatus, produces print data based on the output data, and outputs the print data to the image forming apparatus;
an information extracting unit that retrieves, from the output data, trigger data instructing execution of processing and extracts information within a preset data range subsequent to the trigger data;
a setting unit that sets the data range according to an instruction from outside;
a processing unit that executes the processing based on the trigger data retrieved by the information extracting unit and the information within the data range extracted by the information extracting unit;
a log-information generating unit that generates log information about the processing executed by the processing unit; and
a log-information output unit that outputs the log information generated by the log-information generating unit.

2. The data relay apparatus according to claim 1, wherein when the trigger data retrieved-by the information extracting unit hits a print cancel condition, the processing unit causes the print control unit to delete the output data including the trigger data and causes the image forming apparatus to cancel printing.

3. The data relay apparatus according to claim 2, wherein
the processing unit includes a unit that displays, when the trigger data retrieved by the information extracting unit hits the print cancel condition, a message confirming that the printing is to be canceled, and
when, to the message displayed by the unit, an affirmative response indicating acceptance of print cancellation is received from outside, the processing unit causes the print control unit to delete the output data including the trigger data and causes the image forming apparatus to cancel printing.

4. The data relay apparatus according to claim 1, wherein
the processing unit includes a unit that displays, when the trigger data retrieved by the information extracting unit hits the print cancel condition, a message asking whether or not to suspend printing,
when, to the message displayed by the unit, an affirmative response indicating acceptance of print suspension is received from outside, the processing unit causes the print control unit to delete the output data including the trigger data and causes the image forming apparatus to suspend printing, and
when a negative response indicating denial of print suspension is received from outside, the processing unit causes the print control unit to continue a process necessary for normal printing, that produces the print data from the output data.

5. The data relay apparatus according to claim 1, wherein
the processing unit includes an encoded-data producing unit that produces encoded data according to the trigger data retrieved by the information extracting unit and the information within the data range extracted by the information extracting unit, and
the processing unit causes the print control unit to superimpose the encoded data produced by the encoded-data producing unit on the output data, thereby producing the print data.

6. The data relay apparatus according to claim 5, wherein
the encoded-data producing unit includes a unit that, when the trigger data is data instructing execution of masking processing, produces a masking image of a size specified by the information within the data range as the encoded data, and
the processing unit causes the print control unit to combine the masking image with the output data with reference to a position specified by the information within the data range.

7. The data relay apparatus according to claim 6, wherein the log-information generating unit generates, as the log information, information indicating contents of data at a position to be masked by the masking image.

8. A print control method for a data relay apparatus that includes:
a connecting unit that connects an information processing apparatus to an image forming apparatus so as to allow communication therebetween; and
a print control unit that receives output data from the information processing apparatus, produces print data based on the output data, and outputs the print data to the image forming apparatus,
the print control method comprising:
retrieving, from the output data, trigger data instructing execution of processing;
extracting information within a preset data range subsequent to the trigger data;
setting the data range according to an instruction from outside;
executing the processing based on the trigger data retrieved at the retrieving and the information within the data range extracted at the extracting;
generating log information about the processing executed at the processing; and
outputting the log information generated at the generating.

9. The data relay method according to claim 8, wherein when the trigger data retrieved at the retrieving hits a print cancel condition,
causing the print control unit to delete the output data including the trigger data, and
causing the image forming unit to cancel printing.

10. The data relay method according to claim 9, comprising:
displaying, when the trigger data retrieved at the retrieving hits the print cancel condition, a message confirming that the printing is to be canceled, wherein
the executing includes, when, to the message displayed at the displaying, an affirmative response indicating acceptance of print cancellation is received from outside,
causing the print control unit to delete the output data including the trigger data; and
causing the image forming apparatus to cancel printing.

11. The data relay method according to claim 8, comprising:
displaying, when the trigger data retrieved at the retrieving hits the print cancel condition, a message asking whether or not to suspend printing, wherein
the executing includes, when, to the message displayed at the displaying, an affirmative response indicating acceptance of print suspend is received from outside,
causing the print control unit to delete the output data including the trigger data; and
causing the image forming apparatus to suspend printing, and
the executing includes, when, to the message displayed at the displaying, a negative response indicating denial of print suspend is received from outside,
causing the print control unit to continue a process necessary for normal printing, that produces the print data from the output data.

12. The data relay method according to claim 8, comprising:
producing encoded data according to the trigger data retrieved at the retrieving and the information within the data range extracted in the extracting; and
causing the print control unit to superimpose the encoded data produced at the producing on the output data, thereby producing the print data.

13. The data relay method according to claim 12, comprising:
producing a masking image of a size specified by the information within the data range as the encoded data when the trigger data is data instructing execution of masking processing; and
causing the print control unit to combine the masking image with the output data with reference to a position specified by the information within the data range.

14. The data relay method according to claim 13, comprising:
generating, as the log information, information indicating contents of data at a position to be masked by the masking image.

15. A computer program product comprising a non-transitory computer-readable medium including computer-readable program codes embodied in the medium for controlling a data relay apparatus that includes a connecting unit that connects an information processing apparatus to an image forming apparatus so as to allow communication therebetween, and a print control unit that receives output data from the information processing apparatus, produces print data based on the output data, and outputs the print data to the image forming apparatus,
the program codes, when executed, causing a computer to perform:
retrieving, from the output data, trigger data instructing execution of processing;
extracting information within a preset data range subsequent to the trigger data;
setting the data range according to an instruction from outside;
executing the processing based on the trigger data retrieved at the retrieving and the information within the data range extracted at the extracting;
generating log information about the processing executed at the processing; and
outputting the log information generated at the generating.
